(19) United States
(12) Patent Application Publication
(10) Pub. No.: US 2018/0268779 A1
(43) Pub. Date: Sep. 20, 2018

(54) IMAGE DISPLAY APPARATUS, IMAGE DISPLAY METHOD, AND STORAGE MEDIUM

(71) Applicant: CANON KABUSHIKI KAISHA, Tokyo (JP)

(72) Inventors: Satoshi Nakashima, Kawasaki-shi (JP); Takeyoshi Saiga, Tokyo (JP)

(21) Appl. No.: 15/920,330

(22) Filed: Mar. 13, 2018

(30) Foreign Application Priority Data
Mar. 15, 2017 (JP) 2017-050378

(51) Int. Cl. G09G 5/10; G06T 5/00

(52) U.S. Cl. CPC G09G 5/10; G06T 5/009; G06T 11/60; G09G 2320/046; G09G 2320/0233

(57) ABSTRACT

An image display apparatus according to an embodiment includes a display unit and a correction unit. The display unit includes a display device configured to display an image and an optical system configured to lead light from the display device to an exit pupil. The correction unit is configured to correct a luminance level of an image displayed by the display device using a correction table. The correction table is created on the basis of a luminance distribution of an image on the display device which has been acquired at a position shifted from a position of the exit pupil in a predetermined direction by a predetermined distance.

### BACKGROUND OF THE INVENTION

### Field of the Invention

The present disclosure relates to a technique for correcting unevenness in a luminance distribution which is caused by a display optical system for an image display apparatus.

### Description of the Related Art

Head-mounted image displays (HMDs) for displaying images on display units provided for both the left and right eyes of a user have been known. It is necessary for an image display apparatus such as an HMD to have a high resolution and a wide angle of view, and be compact and lightweight to reduce a sense of discomfort and a sense of fatigue when it is mounted on a user's head. However, in general, as a resolution becomes higher and an angle of view becomes wider and as the size of an apparatus becomes smaller and the weight of the apparatus becomes lighter, unevenness in an image luminance distribution occurs more frequently mainly owing to an optical system.

Japanese Patent Laid-Open No. 2010-16669 discloses a technique for correcting an image to be displayed on a display unit on the basis of information about the optical performance such as image shading of the display unit.

However, Japanese Patent Laid-Open No. 2010-16669 does not disclose how the image shading, on the basis of which image correction is performed, has been designed. Accordingly, when a user observes the peripheral region of an image, the user compares the central region of the image with the peripheral region and sometimes recognizes that there is unevenness in a luminance distribution.

### SUMMARY OF THE INVENTION

The present example embodiments reduce unevenness in a luminance distribution in the central region and peripheral region of an image. An image display apparatus according to an embodiment includes a display unit and a correction unit. The display unit includes a display device configured to display an image and an optical system configured to lead light from the display device to an exit pupil. The correction unit is configured to correct a luminance level of an image displayed by the display device using a correction table. The correction table is created on the basis of a luminance distribution of an image on the display device which has been acquired at a position shifted from a position of the exit pupil in a predetermined direction by a predetermined distance.

Further features will become apparent from the following description of exemplary embodiments with reference to the attached drawings.

### BRIEF DESCRIPTION OF THE DRAWINGS

FIG. 1 is a schematic diagram illustrating an exemplary configuration of an image display system according to a first embodiment.

FIG. 2 is a block diagram illustrating the configuration of an image display system according to the first embodiment.

FIG. 3 is a block diagram illustrating the configuration of a display unit according to the first embodiment.

FIGS. 4A and 4B are schematic diagrams illustrating the configuration of an optical system for a display unit according to the first embodiment.

FIG. 5 is a block diagram illustrating the configuration of a shading correction portion according to the first embodiment.

FIGS. 6A and 6B are diagrams describing a luminance distribution measurement method according to the first embodiment.

FIG. 7 is a diagram illustrating the luminance distribution of an image captured by an image pickup apparatus according to the first embodiment.

FIG. 8 is a diagram describing a shading correction table according to the first embodiment.

### DESCRIPTION OF THE EMBODIMENTS

### First Embodiment

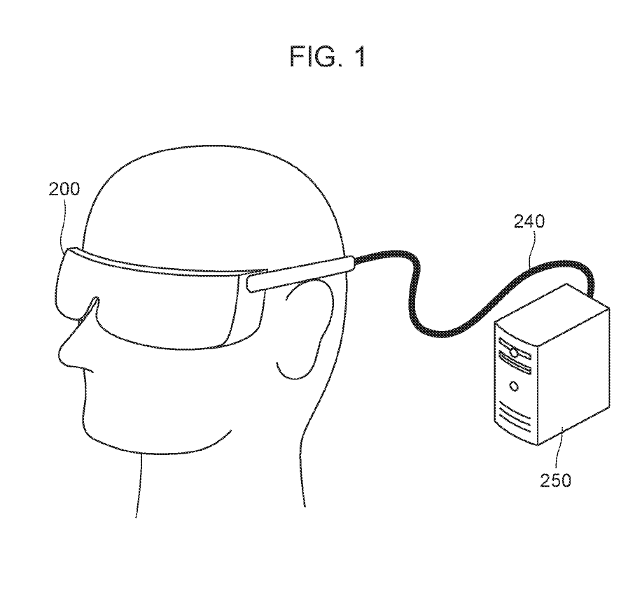

The first embodiment will be described in detail below with reference to the accompanying drawings. FIG. 1 is a schematic diagram illustrating an exemplary configuration of an image display system according to the first embodiment. An image display system according to this embodiment includes an HMD (image display apparatus) 200 that is mounted on a user's head and is configured to provide a virtual space image in front of eyes of the user and a computer apparatus 250 for generating a virtual space image and providing the virtual space image to the HMD 200. The HMD 200 and the computer apparatus (image processing apparatus) 250 are connected to each other by a cable 240. In an image processing system according to this embodiment, the HMD 200 and the computer apparatus (image processing apparatus) 250 communicate with each other using a wired communication path realized by the cable 240. However, a wireless communication path may be used.

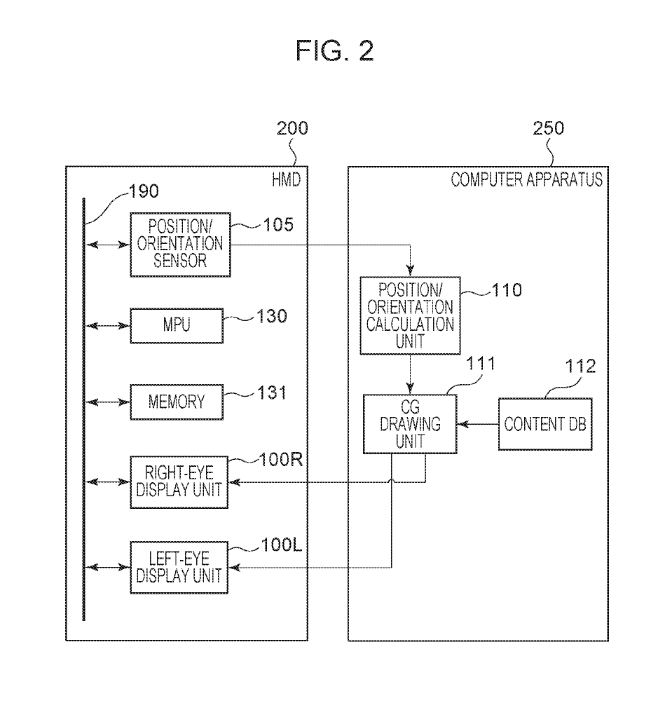

FIG. 2 is a block diagram illustrating the configuration of an image display system according to this embodiment. In the HMD 200, a microprocessing unit (MPU) 130 performs processing using a computer program and data stored in a memory 131, thereby controlling the operations of respective functional units connected to a bus 190 and controlling the operation of the entire HMD 200. The memory 131 stores a computer program and data to be used for processing performed by the MPU 130 and information about image shading to be described below. The memory 131 includes a work area to be used by the MPU 130 at the time of the execution of various pieces of processing.

A position/orientation sensor 105 transmits information about the detected position and orientation of the HMD 200 to the computer apparatus 250. Each of a left-eye display unit 100L and a right-eye display unit 100R performs image processing to be described below upon a CG image generated by the computer apparatus 250 and displays a resultant display image on a display device 1 included therein.

In the computer apparatus 250, a position/orientation calculation unit 110 calculates three-dimensional position/orientation information of the HMD 200 on the basis of position/orientation information detected by the position/orientation sensor 105. A CG drawing unit 111 generates a CG image for the left eye and a CG image for the right eye on the basis of the calculated three-dimensional position/orientation information and virtual image CG content stored in a content DB 112, and transmits the generated CG images to the HMD 200.

The computer apparatus 250 has a hardware configuration including a central processing unit (CPU), a read-only memory (ROM), a random access memory (RAM), a hard disk drive (HDD), and the like. The CPU executes a program stored in the ROM, the HD, or the like, so that the above-described functional configurations realize pieces of processing. The RAM includes a storage area functioning as a work area where the CPU develops and executes a program. The ROM includes a storage area for storing a program and the like to be executed by the CPU. The HDD includes a storage area for storing various programs and various pieces of data to be used by the CPU at the time of the execution of processing.

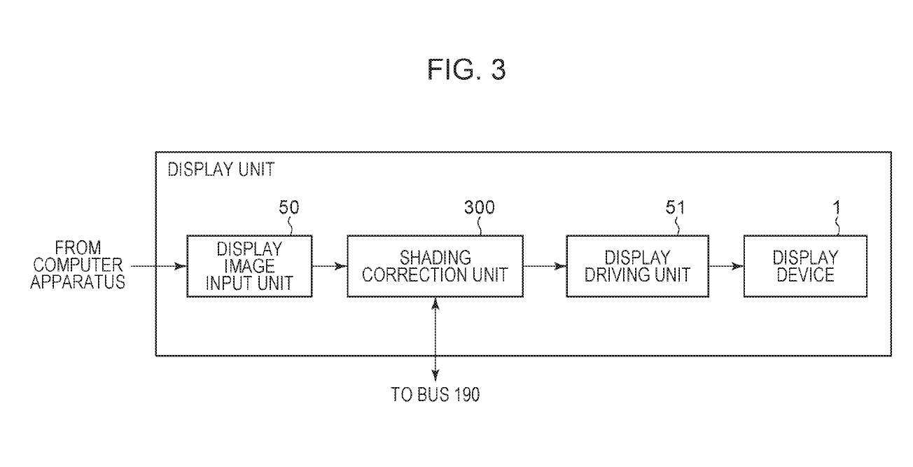

FIG. 3 is a block diagram illustrating the configurations of the left-eye display unit 100L and the right-eye display unit 100R. The left-eye display unit 100L and the right-eye display unit 100R have the same configuration. A display image input unit 50 acquires a virtual space CG image output from the computer apparatus 250 and converts the acquired image into an image signal for display. A shading correction unit 300 performs shading correction processing to be described below upon the image signal for display and transfers a resultant signal to a display driving unit 51. The display driving unit 51 drives the display device 1 to cause the display device 1 to display a display image that has been subjected to the shading correction processing.

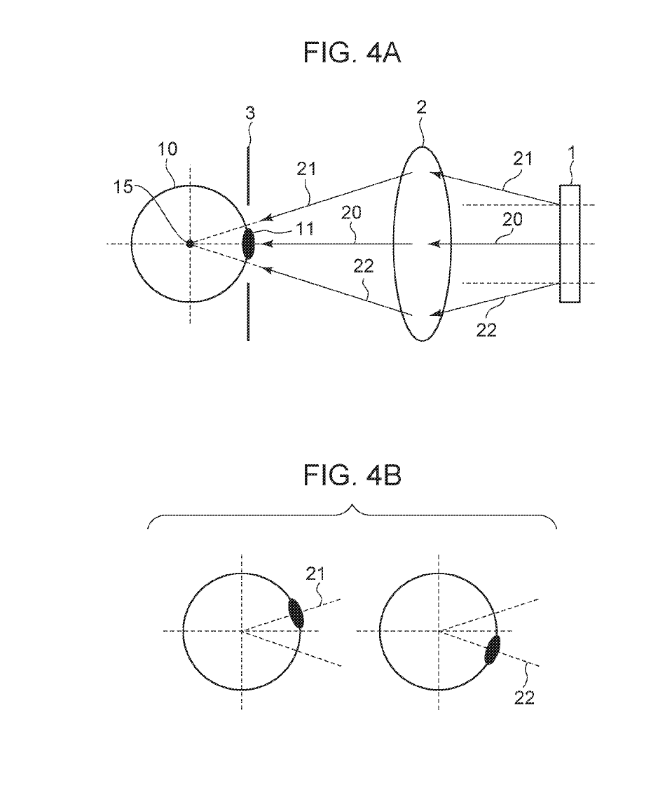

FIGS. 4A and 4B are schematic diagrams illustrating the configuration of an optical system for a display unit according to this embodiment. As illustrated in FIG. 4A, a display unit according to this embodiment has an optical system 2 configured to lead light (visible light) from the display device 1 to an exit pupil 3. A pupil 11 of an eyeball 10 of a user is located at the position of the exit pupil 3. The display device 1 is configured with, for example, a liquid crystal display (LCD) panel or an organic electroluminescent (EL) device. The optical system 2 is configured with, for example, a free-form-surface prism for displaying an image in an enlarged view.

An axis from the center of an image display area of the display device 1 to the center of the exit pupil 3 is called an optical axis. A state in which the pupil 11 is directed toward a light ray 20 along the optical axis is called a state in which the pupil 11 fixates (or gazes) on the image central region. A state in which the pupil 11 is directed toward light rays 21 and 22 each extending from an image peripheral region at the left and right ends or the top and bottom ends of an image on the display device 1 to the exit pupil 3 is called a state in which the pupil 11 fixates (or gazes) on the image peripheral region. FIG. 4B illustrates this state.

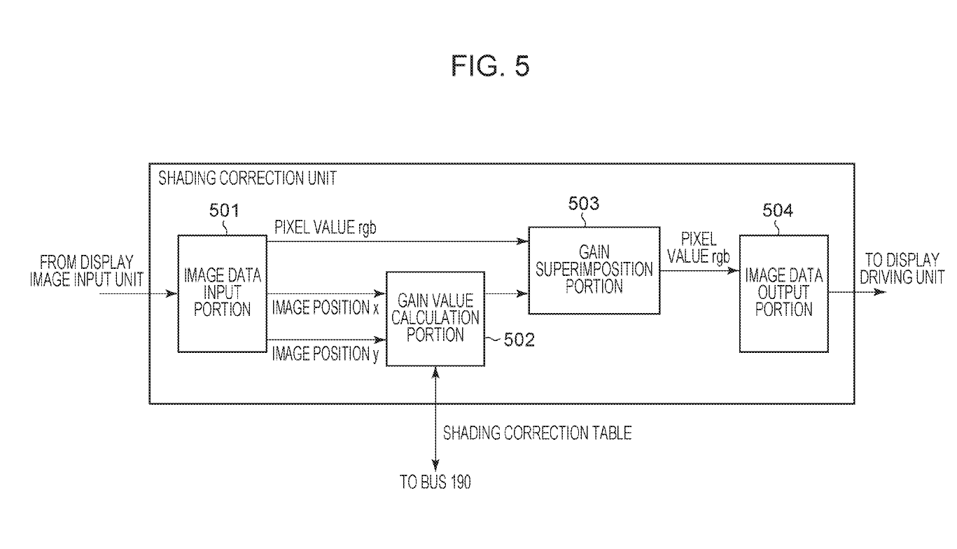

FIG. 5 is a block diagram illustrating the configuration of a shading correction portion according to this embodiment. In the following, processing performed upon a left-eye display image displayed on the left-eye display unit 100L will be described. Since processing performed upon a right-eye display image displayed on the right-eye display unit 100R is symmetric to and is similar to the processing performed upon the left-eye display image, the description thereof will be omitted. In this embodiment, descriptions will be made on the assumption that image data displayed on the display device 1 has the full HD size (1920 pixels in the horizontal direction and 1080 pixels in the vertical direction).

In order to process an image signal for display which has been input from the display image input unit 50 on a pixel-by-pixel basis, the image data input portion 501 calculates pixel values r, g, and b of each pixel and pieces of image position information x and y of the pixel and transfers them to the next processing block. The pieces of image position information x and y are integer values specifying pixel positions in the horizontal and vertical directions of a display image with respect to the origin (1, 1) at the upper-left corner of the display image. The pixel values r, g, and b are red, green, and blue luminance values of the display image, respectively and are integer values typically ranging from 0 to 255.

Upon receiving the pieces of image position information x and y, a gain value calculation portion 502 calculates and determines a gain value (fluctuation coefficient) to be multiplied by the display image. Specifically, the gain value calculation portion 502 refers to a shading correction table stored in the memory 131 via the bus 190 to determine a gain value. The shading correction table has a data format including specified gain values to be multiplied by a display image which correspond to image positions (x, y) with respect to a starting point (origin) of the display image. In this embodiment, descriptions will be made on the assumption that gain values corresponding to all image positions are specified in the shading correction table. However, the shading correction table may have a format in which gain values corresponding to image positions at evenly (or unevenly) spaced lattice points are specified, that is, may include thinned data. In this case, the gain value calculation portion 502 calculates a gain value corresponding to an image position (x, y) by performing, for example, linear interpolation upon a gain value at a lattice point near the image position (x, y). A method of creating the shading correction table stored in the memory 131 will be described below.

A gain superimposition portion 503 multiplies the pixel values r, g, and b by the gain value determined by the gain value calculation portion 502. In this embodiment, all of the pixel values r, g, and b are multiplied by the same gain value. However, different shading correction tables may be prepared for r, g, and b, and the pixel values r, g, and b may be multiplied by different gain values.

An image data output portion 504 resynthesizes the pixel values r, g, and b of each pixel, which has been received from the gain superimposition portion 503, to generate a display image signal, and transfers the generated display image signal to the display driving unit 51. With the above-described configuration, the luminance distribution of a display image can be corrected.

Next, a shading correction table creation method according to this embodiment will be described. A user wearing the HMD 200 can change the direction of the pupil 11 by moving eyeballs, and observe the entire display image from the image central region to the image peripheral region. This means that the direction of the pupil 11 can be changed from the light ray 20 along the optical axis in the center portion of the image to the light rays 21 and 22 in the image peripheral region as illustrated in FIGS. 4A and 4B and this can result in the fixation on the entire image.

In a case where CG colors displayed in the image central region and the image peripheral region of a display image are the same, these colors need to be observed as the same color. In this embodiment, the desired luminance distribution of a display image therefore means that, even when the direction of the pupil 11 is changed, the luminance distribution of the display image has uniformity that at least allows a user to visually recognize colors between which there is a luminance difference as the same color. In this embodiment, a luminance distribution observed in a state in which a user fixates on the entire display image is designed such that it has uniformity. That is, in this embodiment, a shading correction table is created such that a luminance distribution observed in a state in which a user fixates on the entire display image has uniformity.

A method is as follows of acquiring a luminance distribution when the pupil 11 is directed toward the light rays 20, 21, and 22 and fixates on the entire image in a state in which the pupil 11 of the eyeball 10 of a user wearing the HMD 200 is located at the position of the exit pupil 3 as illustrated in FIGS. 4A and 4B. That is, a luminance distribution observed when the pupil 11 directed toward the light ray 20 along the optical axis is placed at a position corresponding to a rotation center 15 of the eyeball 10 is acquired. The reason for this is that a focus at which the light rays 20, 21, and 22 substantially intersect is the rotation center 15 and the luminance distribution of an image on the display device 1 which is acquired at the position corresponding to the rotation center 15 corresponds to a luminance distribution acquired at the time of fixation on the entire image. It is generally said that the diameter of an eyeball in the horizontal direction is 23 to 25 mm. Accordingly, in this embodiment, a position shifted from the position of the exit pupil in an eyeball rotation direction by 12 mm is set as the position corresponding to the rotation center 15 of the eyeball 10. However, this shift length may range from 11 mm to 13 mm in consideration of the typical diameter of an eyeball in the horizontal direction. Also in this case, the effect of this embodiment can be obtained.

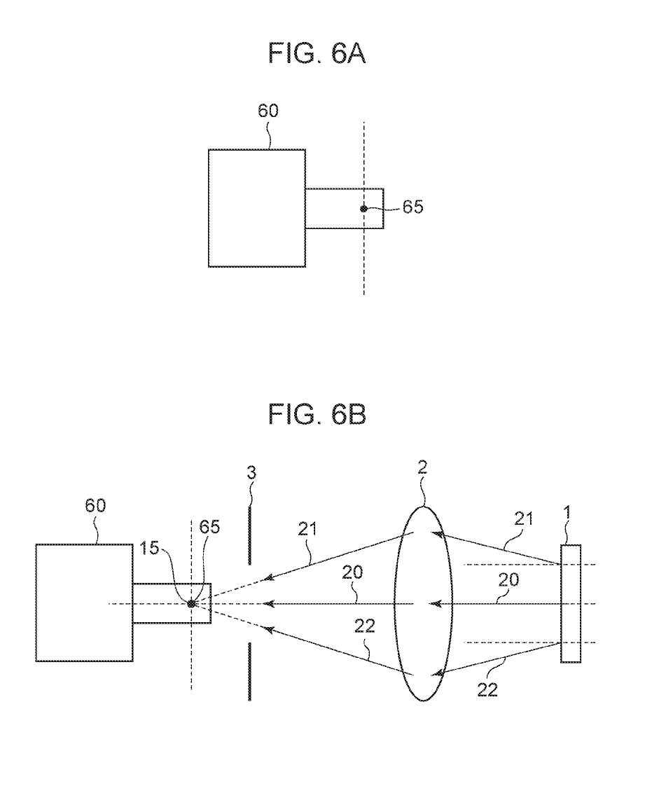

Next, a concrete method will be described of acquiring the luminance distribution of an image on the display device 1 at the position corresponding to the rotation center 15 of the eyeball 10 by measurement. FIGS. 6A and 6B are diagrams describing a luminance distribution measurement method according to this embodiment. FIG. 6A illustrates an image pickup camera 60 used for the measurement of a luminance distribution. The image pickup camera 60 includes an optical system (not illustrated) having an entrance pupil position 65 and an image pickup device such as a CCD image sensor.

FIG. 6B illustrates a state in which the entrance pupil position 65 of the image pickup camera 60 is placed at the position corresponding to the rotation center 15 of the eyeball 10. When image capturing is performed in this state, it is possible to obtain an image equivalent to an image captured at the time of fixation on the entire image including the image central region in which the light ray 20 extends and the image peripheral region in which the light rays 21 and 22 extend. The diameter of a pupil for capturing light at the time of measurement is set to a standard pupil diameter of 4 mm suitable for the observation of a display image with a standard brightness. However, the pupil diameter may be set to 2 mm in the case of a bright display image and 7 mm in the case of a dark display image. Thus, the pupil diameter may be changed in accordance with the brightness of a display image.

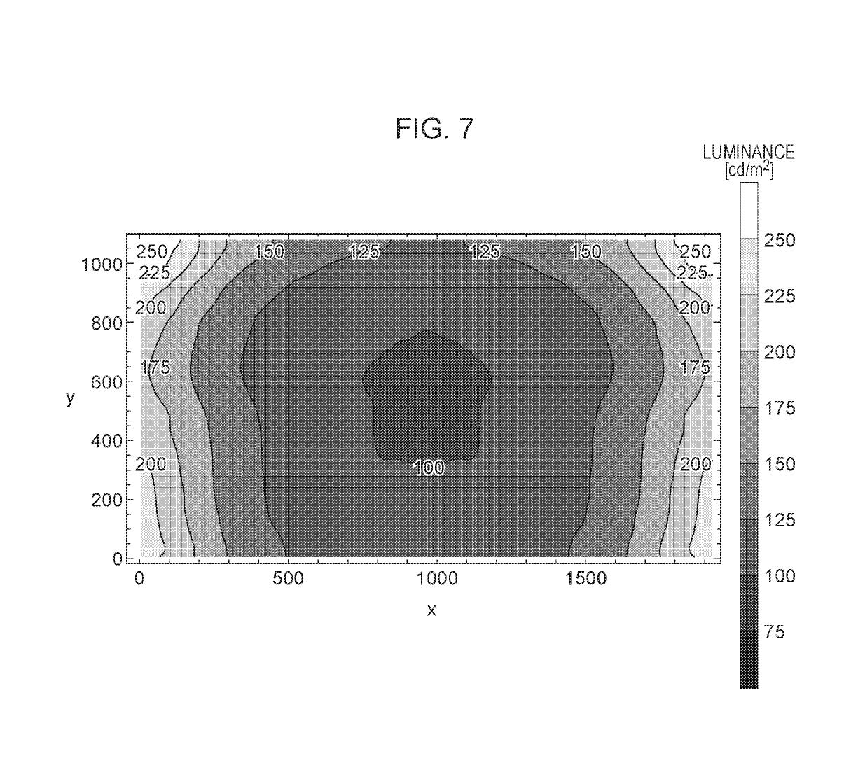

FIG. 7 illustrates the luminance distribution of an image captured in this state. In FIG. 7, a luminance level (cd/m²) at each display image position (x, y) is represented by a contour chart. In this luminance distribution, a luminance level in the image central region is approximately 100 cd/m², a luminance level in an image right-and-left-end region is approximately 175 cd/m² and is increased by approximately 75% as compared with the luminance level in the image central region, and a luminance level in an image upper-left-and-right-end region is approximately 250 cd/m² and is increased by approximately 150% as compared with the luminance level in the image central region. This luminance distribution is the characteristics of an image display apparatus in which image correction processing such as shading correction is not performed. Such a luminance distribution is mainly caused by luminance distribution unevenness due to the optical system 2, but may also be caused by the in-plane light emission unevenness and viewing angle characteristics of the display device 1. It is assumed that the characteristics of luminance distribution unevenness, which is the image pickup shading of the image pickup camera 60, have been checked in advance and the luminance distribution unevenness of the image pickup camera 60 has been corrected by image pickup shading correction. Accordingly, an acquired luminance distribution illustrated in FIG. 7 does not include the luminance distribution unevenness of the image pickup camera 60.

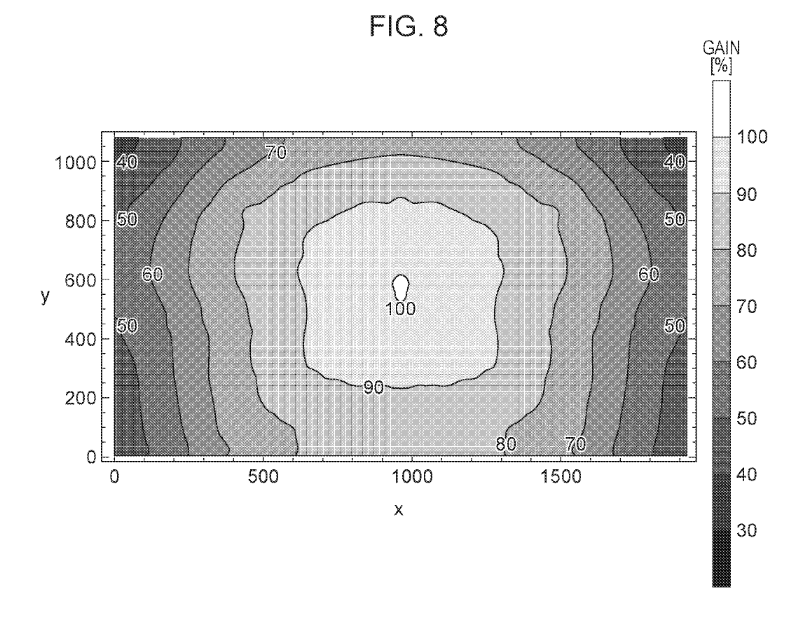

Next, a concrete method of creating a shading correction table from an acquired luminance distribution will be described. FIG. 8 illustrates gain values at display image positions (x, y) in the shading correction table which are used to change a nonuniform luminance distribution acquired at the time of fixation on the entire image to a uniform luminance distribution in image correction. The gain values are calculated by, for example, taking the inverse of a luminance level at each pixel such that a luminance level becomes uniform in the whole image region on the basis of the luminance level in the image central region. The calculated gain value in the image central region is approximately 100%, the calculated gain value in the image right-and-left-end region is approximately 60%, and the calculated gain value in the upper-left-and-right-end region is approximately 40%.

As described above, in this embodiment, a shading correction table is created such that a luminance distribution becomes uniform in a state of fixation on the entire image. Correcting a display image using this shading correction table can reduce luminance distribution unevenness between the image central region and the image peripheral region.

### Other Embodiments

In the above-described embodiment, the desired luminance distribution of a display image that is a shading correction target is a uniform luminance distribution. However, the luminance distribution does not necessarily have to be uniform. That is, in order to prevent image degradation called burning due to the time-dependent deterioration of a luminance level of the display device 1, a luminance level difference may be fall within a predetermined range in the display device 1. In a boundary region between a region where display pixels are visible and a region where display pixels are invisible at the end of a display image, the luminance level difference between the regions is sometimes obtrusive because the region where display pixels are invisible is usually pitch dark and a bright image is displayed in the region where display pixels are visible. In order to prevent this, a luminance distribution may be provided in which a luminance level gradually decreases toward the ends of an image which are the image boundary region in the mage peripheral region.

In the above-described embodiment, a luminance distribution measured by the image pickup camera 60 is used for the creation of a shading correction table. However, the luminance distribution of a display image in a state in which the pupil 11 is placed at a position where the whole image region of the display image is fixated on may be acquired from a calculation result of, for example, light ray tracking in an optical system.

In the above-described embodiment, as a luminance distribution at the time of fixation on the whole image region of a display image, there is acquired a luminance distribution observed when the pupil 11 is placed at a position corresponding to the rotation center 15 of the eyeball 10 at the time of placement of the pupil 11 of the eyeball 10 of an observer at the position of the exit pupil 3. The rotation center 15 of the eyeball 10 is an optimum position. However, even if a luminance distribution is acquired at a position near the rotation center 15 which is shifted from the position of the exit pupil 3 in a predetermined direction, preferably in the direction of the rotation center 15 of the eyeball 10, by a predetermined distance, the effect of the present disclosure can be obtained.

In the above-described embodiment, a position shifted from the position of the exit pupil in the eyeball rotation direction by 12 mm is set as the position corresponding to the rotation center 15 of the eyeball 10 and a luminance distribution is acquired as the set position, because it is generally said that the diameter of an eyeball in the horizontal direction is 23 to 25 mm. However, since there are differences among individuals in the diameter of an eyeball in the horizontal direction, shading correction tables may be created on the basis of corresponding luminance distributions acquired at a plurality of positions. For example, positions shifted from the position of the exit pupil in the eyeball rotation direction by 11.5, 12.0, and 12.5 mm may be set as the position corresponding to the rotation center 15 of the eyeball 10 and luminance distributions may be acquired at these positions. Subsequently, shading correction tables may be created on the basis of the corresponding acquired luminance distributions. When a user uses an HMD, the user may actually observe images corrected with the corresponding shading correction tables, specify one of the images which is felt to have the smallest luminance unevenness, and use the correction table that has been used to correct the specified image.

In the above-described embodiment, a luminance distribution is acquired using a standard pupil diameter of 4 mm and a shading correction table is created on the basis of the luminance distribution. However, since a user's pupil diameter varies depending on the brightness of a display image, shading correction tables corresponding to a plurality of pupil diameters may be created. When a user uses an HMD, the user may select and use one of the shading correction tables on the basis of the brightness of a display image (for example, the total of luminance values r, g, and b of all pixels in the display image).

In the above-described embodiment, an example of an image display system for virtual reality (VR) has been described. However, an embodiment can be applied to an image display system for mixed reality (MR). For example, in a so-called video see-through HMD, cameras provided for both the left and right eyes capture the images of real space and the pieces of data of the captured images are transmitted to an image generation apparatus. The image generation apparatus superimposes a CG image that is a virtual image on the captured images of the real space to generate a composite image and transmits the composite image to the HMD. A user wearing the HMD can observe the composite image generated as above.

An image display apparatus is not limited to an HMD. An embodiment can be widely applied to image display apparatuses each including a display optical system, for example, electronic binoculars.

Embodiments can also be realized by supplying a program for realizing one or more functions of the above-described embodiments to a system or an apparatus via a network or a storage medium and causing one or more processors in the computer of the system or apparatus to read out and execute the program. Furthermore, embodiments can also be realized by a circuit (e.g., application specific integrated circuit (ASIC)) for performing one or more functions of the above-described embodiments.

With the above-described configuration, it is possible to reduce unevenness in a luminance distribution in the central region and peripheral region of an image.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-050378 filed Mar. 15, 2017 which is hereby incorporated by reference herein in its entirety.

What is claimed is:

1. An image display apparatus comprising:
a display unit including a display device configured to display an image and an optical system configured to lead light from the display device to an exit pupil; and
a correction unit configured to correct a luminance level of an image displayed by the display device using a correction table,
wherein the correction table is created on the basis of a luminance distribution of an image on the display device which has been acquired at a position shifted from a position of the exit pupil in a predetermined direction by a predetermined distance.

2. The image display apparatus according to claim 1, wherein the correction table is created such that a luminance level difference of an image displayed by the display device falls within a predetermined range.

3. The image display apparatus according to claim 1, wherein the correction table is created on the basis of a luminance distribution of an image on the display device which has been captured by an image pickup apparatus with its entrance pupil placed at the position shifted by the predetermined distance.

4. The image display apparatus according to claim 1, wherein the predetermined direction is a direction from the position of the exit pupil toward a position corresponding to a rotation center of an eyeball of a user at a time of placement of a pupil of the eyeball of the user at the position of the exit pupil.

5. The image display apparatus according to claim 1, wherein the predetermined distance is in a range of 11 mm to 13 mm.

6. The image display apparatus according to claim 1, wherein the correction unit corrects an image using a single correction table selected from among a plurality of correction tables created on the basis of a plurality of luminance distributions of an image on the display device which have been acquired at respective positions shifted from the position of the exit pupil in a predetermined direction by a plurality of different distances.

7. The image display apparatus according to claim 6, wherein the correction unit corrects an image using a correction table specified by a user from among the plurality of correction tables.

8. The image display apparatus according to claim 1, wherein the correction unit corrects an image using a single correction table selected from among a plurality of correction tables created on the basis of a plurality of luminance distributions of an image on the display device which have been acquired using a plurality of different pupil diameters.

9. The image display apparatus according to claim 8, wherein the correction unit selects one of the plurality of correction tables on the basis of a brightness of an image displayed by the display device and corrects the image using the selected correction table.

10. The image display apparatus according to claim 1, wherein the image display apparatus is mounted on a user's head when used.

11. The image display apparatus according to claim 1, wherein the display device displays a composite image generated by superimposing an image of real space and a virtual image.

12. An image display method comprising:
causing a display unit including a display device configured to display an image and an optical system configured to lead light from the display device to an exit pupil; and
correcting a luminance level of an image displayed by the display device using a correction table,
wherein the correction table is created on the basis of a luminance distribution of an image on the display device which has been acquired at a position shifted from a position of the exit pupil in a predetermined direction by a predetermined distance.

13. The image display method according to claim 12, wherein the correction table is created such that a luminance level difference of an image displayed by the display device falls within a predetermined range.

14. The image display method according to claim 12, wherein the correction table is created on the basis of a luminance distribution of an image on the display device which has been captured by an image pickup apparatus with its entrance pupil placed at the position shifted by the predetermined distance.

15. The image display method according to claim 12, wherein the predetermined direction is a direction from the position of the exit pupil toward a position corresponding to a rotation center of an eyeball of a user at a time of placement of a pupil of the eyeball of the user at the position of the exit pupil.

16. The image display method according to claim 12, wherein the predetermined distance is in a range of 11 mm to 13 mm.

17. The image display method according to claim 12, wherein, in the correcting, an image is corrected using a single correction table selected from among a plurality of correction tables created on the basis of a plurality of luminance distributions of an image on the display device which have been acquired at respective positions shifted from the position of the exit pupil in a predetermined direction by a plurality of different distances.

18. The image display method according to claim 17, wherein, in the correcting, an image is corrected using a correction table specified by a user from among the plurality of correction tables.

19. The image display method according to claim 12, wherein, in the correcting, a single correction table is selected, on the basis of a brightness of an image displayed by the display device, from among a plurality of correction tables created on the basis of a plurality of luminance distributions of an image on the display device which have been acquired using a plurality of different pupil diameters and the image is corrected using the selected correction table.

20. A nonvolatile storage medium storing a program causing a computer to execute each step of an image display method, the image display method comprising:
causing a display unit including a display device configured to display an image and an optical system configured to lead light from the display device to an exit pupil; and
correcting a luminance level of an image displayed by the display device using a correction table,
wherein the correction table is created on the basis of a luminance distribution of an image on the display device which has been acquired at a position shifted from a position of the exit pupil in a predetermined direction by a predetermined distance.
